(19) United States
(12) Patent Application Publication
(10) Pub. No.: US 2009/0087532 A1
(43) Pub. Date: Apr. 2, 2009

(54) Milk Frother

(75) Inventor: Hermann Meier, Doettingen (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Cafina AG, Hunzenschwil (CH)

(21) Appl. No.: 12/231,619

(22) Filed: Sep. 4, 2008

(30) Foreign Application Priority Data
Sep. 28, 2007 (CH) 01510/07

(51) Int. Cl. A23L 2/54; B01F 3/04

(52) U.S. Cl. 426/474; 99/323.1

(57) ABSTRACT

Proposed is a milk frother including a milk feed conduit (2), a pump (5) for forwarding the milk, at least one means for heating the milk, as well as a blender element (1) for blending the milk with the frothing medium. The milk is first heated and then air is jetted into the milk. After this, the milk/air blend is fed to a blending section of the blender element (1) where it is multiply deflected and/or decombined to generate high-quality milk froth.

### BACKGROUND

The invention relates to a milk frother and to a method for creating milk froth. Such devices find application especially in, or together with, espresso coffee machines. The milk froth created by the device is used, for example, in producing a cappuccino or latte.

A wealth of so-called emulsifiers is known for generating milk froth which generally feature a blender element provided with a steam feed conduit porting into a suction chamber. This suction chamber is connected to a milk feed conduit and an air feed conduit. By exploiting what is called the Venturi effect the flow of steam creates a negative pressure in the suction chamber causing the milk to be drawn into the suction chamber via the milk feed conduit and air via the air feed conduit. This steam/air/milk mixture is transformed into a turbulent flow in a subsequent emulsifier chamber, resulting in a hot emulsion of milk and air. Steam is thus exploited, on the one hand, to heat the milk and, on the other, to draw in the air serving as the frothing medium. Emulsifiers of this kind are known, for example, from EP-A-0 195 750 as well as from EP 0 858 757.

Since in the majority of known emulsifiers the air is jetted to a sole location, means need to be provided to subsequently blend the air and the milk into a homogenous milk froth.

Known from EP-A-0 600 826 is a device for producing frothed milk for cappuccino-coffee or similar beverages. This device comprises an electrically heated receptacle accommodating the milk, followed downstream by a baffle connected at the inlet end to the milk feed conduit and an air feed conduit leading thereinto. To power the milk feed an electrically operated pump is provided. At its outlet end the device features an aperture porting into a chamber separating the froth from the liquid milk flow. The baffle is composed of a cylinder housing an element structured baffled circumferentially to form a labyrinth passage through which the milk is forced.

Known, in conclusion, from EP-A 1 593 330 is a method and a device for creating frothed milk or hot beverages. This device comprises a pump by means of which milk is drawn from the receptacle and pumped to an outlet. Disposed in the milk feed conduit is a continuous flow heater for heating the milk. The milk feed conduit is connected to an air feed conduit, the latter featuring a variable air flow controller. Arranged in the air feed conduit is an actuator valve by means of which the air feed for generating hot milk can be shut off.

### SUMMARY

It is on the basis of this prior art as described that one object of the invention is to sophisticate a milk frother to make it capable of creating a high-quality milk froth whilst rendering the frother compact and simply structured.

By jetting the milk with air serving as the frothing medium and then multiply deflecting and/or decombining the milk/air blend in a blending section a high-quality milk froth can now be created by simple ways and means. The blender element itself can be engineered highly compact.

But, in any case, jetting the milk with air serving as the frothing medium and then multiply deflecting and/or decombining the milk/air blend in a blending section is the basic requirement for creating a particularly high-quality milk froth which excels, among other things, by its homogenous, stable, firm and minute froth bubbles.

It is particularly preferred to heat the milk by means of an electrically operated heater element before introducing it into the blender element, it namely having been discovered that feeding the milk when already heated is of advantage to the quality of the final product and that, on the one hand, heating the milk by means of an electrically operated heater element, instead of the usual steam-heating has likewise a positive effect on the quality of the milk froth since the milk is not additionally watered down.

Certain features of embodiments of the milk frother of the present invention include: the blender element includes at least six blending vanes for deflecting and/or decombining the milk/air blend; and the blender element includes at least two spirally configured blending vanes setting the milk/air blend in rotation, the blending vanes being arranged and configured such that the direction of rotation is repeatedly changed along the blending section. In additional features, the milk frother further comprises means for heating the milk circuited upstream of the blender element, and in certain embodiments, the means for heating includes an electrically operated heater element, particularly an electrically operated continuous-flow heater, and further comprises a temperature sensor for sensing the temperature of the milk. In still other embodiments, the milk frother includes a pump for forwarding air and at least one means for varying the air flow jetted to the milk per unit of time, wherein the means for varying the air flow can include a variable restrictor disposed in the air feed conduit, and further wherein upstream of the pump for forwarding the air is a filter. In some embodiments, parts of the blender element coming into contact with the milk are made of a hydrophobic and/or oleophobic material.

In another embodiment of the invention, a method is provided for creating milk froth with a milk frother as set forth above. In certain aspects of the method: the milk before being introduced into the blender element is jetted with air as the frothing medium, after which the milk/air blend is multiply deflected and/or decombined and/or caused to rotate in the blender element; the milk/air blend is deflected at least six times and/or decombined at least six times in the blender element; and the milk/air blend is caused to rotate in the blender element, the direction of rotation being changed at least twice to generate a turbulent flow. In other embodiments, the method is characterized in that before being introduced into the blender element the milk is heated to a temperature of at least 50° C., particularly at least to 60° C.; or that the air flow jetted into the milk per unit of time is varied.

### DESCRIPTION OF THE FIGURES

A preferred embodiment of the invention will now be described with reference to the drawings in which:

FIG. 1 is a diagrammatic illustration of the milk frother;

FIG. 2a is a diagrammtic illustration of a blender element in a first example aspect, and

FIG. 2b is a diagrammtic illustration of a blender element in a further example aspect.

### DESCRIPTION OF THE EMBODIMENTS

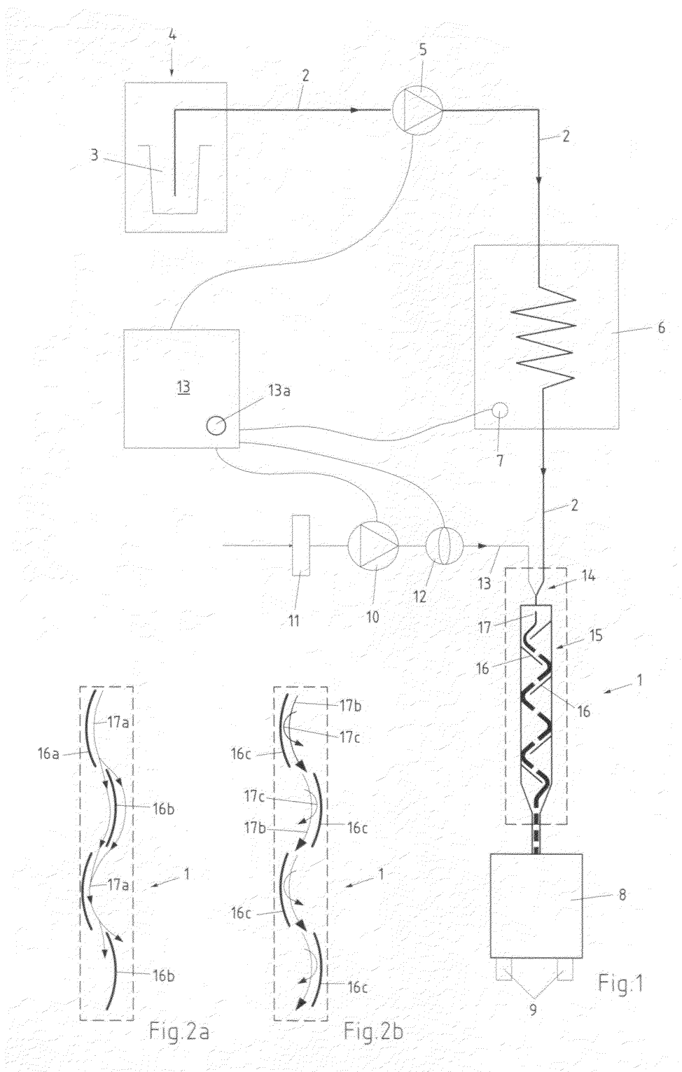

Referring now to the FIG. 1 there is illustrated how the milk frother comprises a blender element 1 in which the throughflow of milk is jetted with air to froth the milk. The blender element 1 is connected by a milk feed conduit 2 to a milk receptacle 3 held in a chiller 4. For pumping the milk a milk pump 5 is provided followed by an electrically operated continuous-flow heater 6 to heat the milk. The continuous-flow heater 6 is provided with a temperature sensor 7, shown diagrammatically, by means of which the temperature of the milk heated in the continuous-flow heater 6 is sensed. An air pump 10 serves to jet air, upstream and downstream of which an air filter 11 and a orifice 12 is provided. The air filter 11 may be engineered as a conventional mechanical filter or, for example, it may take the form of an active carbon filter. By means of the variable orifice 12 the air flow jetted into the milk per unit of time can be varied. Provided furthermore is an electronic controller 13 which is electrically connected to the two pumps 5, 10 as well as to the continuous-flow heater 6 and temperature sensor 7 and serves to control the complete milk frother. The controller 13 features at least one button 13a for starting and stopping frothing. At the outlet end the blender element 1 is connected to a discharge element 8 comprising two outlets 9 via which frothed milk can emerge. This discharge element 8 may form a component of a coffee machine, it in this case also serving as the outlet for the prepared coffee beverages.

The blender element 1 comprises a first section 14 in which the two media, namely the milk and the air are brought together. This first section 14 is followed by the actual blender section 15 serving to homogenously blend the two media to create a fine-pore milk froth. The blender section 15 includes a static blender provided with a plurality of blending vanes blending vanes 16 resulting in multiple deflection of the two media or milk/air blend. This static blender may take the form of an interchangeable blender insert. Simultaneously with the deflection a turbulent flow can be generated. In addition to, or instead of, the cited blending vanes 16 separator elements may also be provided, causing decombining of the milk/air blend, the decombined proportions also always being able to be recombined. Tests have demonstrated that for a good blending of the two media the blend needs to be deflected and/or decombined roughly 12 to 36 times. Where necessary the blend may also be caused to rotate.

How well static blenders perform is dictated especially by the number and geometry of the blender elements, the blending vanes, interblending being achieved by two effects, namely the separation in the flow and radial interblending.

When the blend of milk and air streams through the blender element practically in a laminar flow a relatively large number of blending vanes needs to be provided to ensure thorough interblending of the two media, milk and air. Tests to this end have demonstrated that the blend needs to be deflected and/or decombined roughly 12 to 36 times to thoroughly interblend the two media.

When the flow of the milk/air blend is rendered turbulent within the blender element, the number of blending vanes can be reduced. In a spiral blender in which the blender elements have a spiral geometry and the rotation of the blend is changed in passing from one vane to the next, a resulting highly turbulent transition zone is mainly responsible for thorough interblending. With such a blender element geometry the number of vanes can be reduced to 2 to 4, for example.

Although in this example only four blending vanes 16 are shown, tests have shown it to be an advantage when at least six, particularly at least twelve blending vanes 16 are provided for deflecting and/or decombining the milk/air blend.

Preferably the blending vanes 16 are configured such that the blend is additionally caused to rotate and to change its direction of rotation along the blending section multiply, where necessary.

The functioning of the milk frother as shown in FIG. 1 will now be detailed:

Pressing the button 13a starts frothing, this activating both the milk pump 5 and the continuous-flow heater 6 so that the milk forwarded from the milk receptacle 3 is heated in the continuous-flow heater 6 to then flow into the blender element 1. At the same time the pump 10 is activated, resulting in air being jetted into the blender element 1. Preferably the milk flowing into the blender element 1 is jetted with air right from the start.

Since the milk flowing into the blender element 1 has already been heated to a predetermined temperature, air is jetted into hot milk. The temperature of the heated milk at the outlet of the continuous-flow heater 6 can be sensed by means of the temperature sensor 7 and tweaked to any predetermined final temperature by means of the controller 13. The milk is usually heated in the continuous-flow heater 6 to a temperature in the range of approximately 60° C. to 70° C. The air flow jetted per unit of time can be varied by means of the orifice 12.

Air-jetting the milk results in air being instantly blended in the hot milk. The two media of this milk/air blend are then intensively and uniformly interblended in the blender section 15 by multiple deflecting and/or decombining so that at the outlet of the blender element 1 a uniform fine-pore milk froth is made available. When correctly dimensioned the blender element 1 can be installed in any position without appreciably detrimenting the quality of the created milk froth, it being irrelevant whether the blender element passes the flow of the milk vertically, horizontally or inclined.

Particularly the parts of the blender element coming into contact with the milk are made of a hydrophobic and/or oleophobic material, for example. PTFE (teflon).

The benefit of the milk frother in accordance with the invention is, among other things, that it is engineered relatively simple, involving relatively few single parts whilst assuring a high-quality, namely an homogenous, fine-porous and stable, milk froth with the added advantage of it being directly available at the outlet of the blender element 1, thus doing away with the need of a downstream emulsifier. As compared to conventional frothers there is now also hardly any need for valves or the like, thus enabling the frother to be engineered highly compact at low cost. On top of this, the milk frother has demonstrated itself to be uncritical to changes in the ambient conditions or in the operating parameters.

It is to be noted that heating the milk by means of an electrically operated heating element 6, as compared to using steam, results in a better-quality milk froth since steaming the milk causes the steam to condense, watering down the milk and negatively influencing both the appearance and taste of the final product in the form of milk froth.

Due to the milk and air being jetted the absolute rate of flow per unit of time of milk and air, on the one hand, can be varied whilst, on the other, the ratio of milk to air can also be varied by, for example, incorporating an adjustable orifice 12.

On top of this, siting heater and blender separately reduces the risk of milk deposits in the blender element 1 since this eliminates these hot locations in the blender element 1.

Where necessary, the milk frother in accordance with the invention can used to froth cold milk. In this case, the milk is introduced directly into the blender element 1, i.e. bypassing the continuous-flow heater 6, although it would be just as possible to also pass the milk through the continuous-flow heater but with it de-activated. In addition, a chiller could also be included to chill the milk down to a predefined maximum temperature before being introduced into the blender element 1. In other words, it is just as possible to froth both cold and hot milk with one and the same blender element 1. When frothing cold milk too, it is of a major advantage when the air serving as the frothing medium is jetted into the stream of milk.

Referring now to FIG. 2a there is illustrated diagrammatically the flow of the milk/air blend through a first example aspect of a blender element 1 featuring a plurality of blending vanes 16a, 16b, the one blending vane 16a in this arrangement serving to deflect the milk/air blend whilst the other blending vanes 16b are provided to decombine the milk/air blend. It is, of course, just as possible the use combined blending vanes which both deflect and decombine the milk/air blend. But, in any case, the number and geometry of the blending vanes 16a, 16b are required to ensure that a uniform milk froth materializes at the outlet of the blender element. As already explained, it has been discovered to be particularly of an advantage to provide at least six, especially at least twelve blending vanes 16a, 16b for deflecting and/or decombining the milk/air blend. The lines 17a in FIG. 2a indicate the flow of the milk/air blend through the blender element.

Referring now to FIG. 2b there is illustrated diagrammatically the flow of the milk/air blend through a further example aspect of a blender element 1 configured as a spiral blender featuring a plurality of spirally configured blending vanes 16c resulting in the milk/air blend being rotated. The blending vanes 16c form an axial train so that the direction of rotation of the milk/air blend changes with each blending vane as indicated by the arrows 17b. The small arrows 17c also indicate how the milk/air blend is interblended radially, whereby the difference in the radial flow velocity can be minimized. But, in any case, a uniform flow velocity over the full cross-section ensures uniform decombining of the bubbles and their size in the froth.

Configuring the blender element 1 basically as a spiral blender has the major advantage that a spiral blender has no dead zones, especially being effective in reducing the risk of deposits forming by achieving a good self-cleaning effect.

1. A milk frother including a milk feed conduit (2), a pump (5) for forwarding the milk, as well as a blender element (1) for blending the milk with the frothing medium, characterized in that the milk frother comprises means for jetting air serving as the frothing medium to the throughflow of milk and that the blender element (1) is provided with a blender section (15) featuring deflectors in which the milk/air blend is multiply deflected and/or decombined and/or rotated.

2. The milk frother as set forth in claim 1, characterized in that the blender element (1) comprises at least six blending vanes (16a, 16b) for deflecting and/or decombining the milk/air blend.

3. The milk frother as set forth in claim 1, characterized in that the blender element (1) comprises at least two spirally configured blending vanes (16c) setting the milk/air blend in rotation, the blending vanes (16c) being arranged and configured such that the direction of rotation is repeatedly changed along the blending section.

4. The milk frother as set forth in claim 1, characterized in that the frother comprises means for heating the milk circuited upstream of the blender element (1).

5. The milk frother as set forth in claim 4, characterized in that the means for heating the milk comprises an electrically operated heater element, particularly an electrically operated continuous-flow heater (6).

6. The milk frother as set forth in claim 4, characterized in that the milk frother comprises a temperature sensor (7) for sensing the temperature of the milk.

7. The milk frother as set forth in claim 1, characterized in that the milk frother comprises a pump (10) for forwarding air and at least one means for varying the air flow jetted to the milk per unit of time.

8. The milk frother as set forth in claim 7, characterized in that the means for varying the air flow fed to the milk per unit of time is a variable restrictor disposed in the air feed conduit (13).

9. The milk frother as set forth in claim 7, characterized in that upstream of the pump for forwarding the air is a filter (11).

10. The milk frother as set forth in claim 1, characterized in that at least the parts of the blender element (1) coming into contact with the milk are made of a hydrophobic and/or oleophobic material.

11. A method for creating milk froth with a milk frother configured as set forth in claim 1, characterized in that the milk before being introduced into the blender element (1) is jetted with air as the frothing medium, after which the milk/air blend is multiply deflected and/or decombined and/or caused to rotate in the blender element (1).

12. The method as set forth in claim 11, characterized in that the milk/air blend is deflected at least six times and/or decombined at least six times in the blender element (1).

13. The method as set forth in claim 11, characterized in that the milk/air blend is caused to rotate in the blender element (1), the direction of rotation being changed at least twice to generate a turbulent flow.

14. The method as set forth in claim 11, characterized in that before being introduced into the blender element (1) the milk is heated to a temperature of at least 50° C., particularly at least to 60° C.

15. The method as set forth in claim 11, characterized in that the air flow jetted into the milk per unit of time is varied.

16. The method as set forth in any of the claim 12, characterized in that before being introduced into the blender element (1) the milk is heated to a temperature of at least 50° C., particularly at least to 60° C.

17. The method as set forth in any of the claim 13, characterized in that before being introduced into the blender element (1) the milk is heated to a temperature of at least 50° C., particularly at least to 60° C.

18. The method as set forth in any of the claim 12, characterized in that the air flow jetted into the milk per unit of time is varied.

19. The method as set forth in any of the claim 13, characterized in that the air flow jetted into the milk per unit of time is varied.

20. The method as set forth in any of the claim 14, characterized in that the air flow jetted into the milk per unit of time is varied.
